(19) United States
(12) Patent Application Publication
(10) Pub. No.: US 2003/0191746 A1
(43) Pub. Date: Oct. 9, 2003

(54) IMAGE MANAGING APPARATUS AND METHOD, IMAGE RETRIEVING APPARATUS AND METHOD, AND STORAGE MEDIUM

(76) Inventors: RYO FUJIMOTO, TOKYO (JP); TORU FUKUMOTO, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/458,689

(22) Filed: Dec. 10, 1999

(30) Foreign Application Priority Data
Dec. 16, 1998 (JP) 375479/1998
Dec. 16, 1998 (JP) 375480/1998

(51) Int. Cl. G06F 7/00

(52) U.S. Cl. 707/3

(57) ABSTRACT

The present invention provides an image managing apparatus offering an improved retrieving ability. The image managing apparatus manages images stored in a hard disk drive in association with image management information. The image management information includes information specified in object units assigned to objects contained in an image. An object unit consists of divisions in which the position of an object in a screen, a pointer indicating a qualification unit, a general name of the object, a proper noun thereof, and pointers indicating other object units are specified respectively. The pointer indicating a qualification unit indicates a position at which the qualification unit resides. Qualifiers appended to the object are specified in the qualification unit. The pointers indicating other object units indicate other linked object units. The other object units include an internal relationship unit, a state unit, and a relationship unit.

### BACKGROUND OF THE INVENTION

1. Field of the Invention

The present invention relates to an image managing apparatus for retrievably managing images stored in memory means, an image retrieving apparatus for retrieving an image stored in an image memory, an image managing method, an image retrieving method, and a storage medium.

2. Description of the Related Art

According to an image managing method for retrievably managing images stored in memory means, information serving as keywords are appended one after another to images. The images are managed in association with the appended information. For retrieving a thus managed image, a keyword equivalent to information with which the image is managed is input. Candidate images are then retrieved based on the interaction of the input keyword with information with which the image is managed.

However, according to the foregoing image managing method, images are managed in association with information appended one after another to the images. A keyword to be input for retrieving an image is an equivalent of information appended to the image. Therefore, a high retrieving ability cannot be achieved. Candidate images not including a desired image or candidate images not needed at all may be extracted as a result of retrieval. The retrieving ability is therefore low.

An object of the present invention is to provide an image managing apparatus, an image managing method, and a storage medium offering an improved retrieving ability.

Another object of the present invention is to provide an image managing apparatus, an image managing method, and a storage medium enabling easy input of information with which an image is managed.

Still another object of the present invention is to provide an image retrieving apparatus, an image retrieving method, and a storage medium enabling easy input of retrieval information with which an image is retrieved.

### SUMMARY OF THE INVENTION

According to one aspect of the present invention, there is provided an image managing apparatus for managing retrievable images. The image managing apparatus includes input means for inputting relevant information concerning an object within an image, and memory means in which relevant information input by the input means is stored in association with objects.

### BRIEF DESCRIPTION OF THE DRAWINGS

FIG. 1 is a block diagram showing the configuration of an embodiment of an image managing apparatus in accordance with the present invention;

FIG. 2A to FIG. 2E show the structure of an object unit employed in managing an image by the image managing apparatus shown in FIG. 1;

FIG. 3 shows an example of images managed by the image managing apparatus shown in FIG. 1;

FIG. 4 shows an example of descriptions of the image shown in FIG. 3 to be specified in an object unit;

FIG. 5 shows the structure of supplementary information employed in managing an image by the image managing apparatus shown in FIG. 1;

FIG. 6 is a flowchart describing a procedure of inputting object unit information to be used by the image managing apparatus shown in FIG. 1;

FIG. 7 is a flowchart describing a procedure of inputting relationship unit information to be used by the image managing apparatus shown in FIG. 1; and

FIG. 8 is a flowchart describing a retrieval process of the image managing apparatus shown in FIG. 1.

### DESCRIPTION OF THE PREFERRED EMBODIMENT

An embodiment of the present invention will be described below with reference to the drawings.

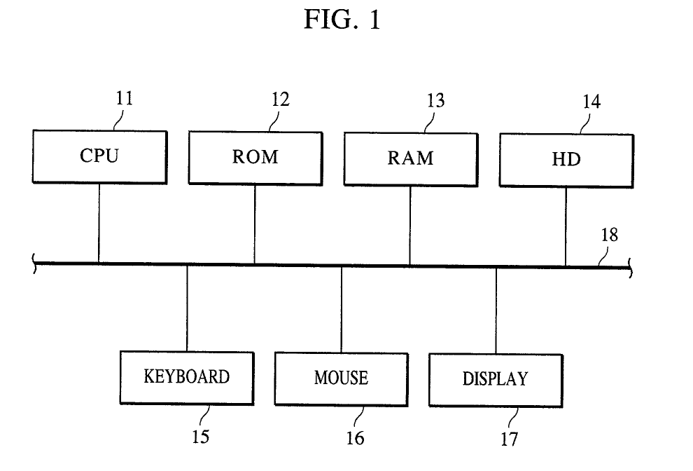

FIG. 1 is a block diagram showing the configuration of an embodiment of an image managing apparatus in accordance with the present invention.

An image managing apparatus has, as shown in FIG. 1, a CPU 11. The CPU 11 runs processes for, for example, image management and image retrieval according to a program stored in a ROM 12. A RAM 13 is used to provide a work area for the CPU 11.

A keyboard 15, a mouse 16, a display 17 capable of displaying images in colors, and a hard disk drive (HD) 14 are connected to the ROM 12, the RAM 13, and the CPU 11 by a bus 18. The CPU 11 controls these blocks. The keyboard 15 includes various kinds of keys used to designate various kinds of environments for data input accompanying each processing, processing, or operations. The mouse 16 is used to instruct the data input accompanying each processing, processing, or operations. The display 17 displays an image contained in an image file stored in the hard disk drive 14, a window assigned to each processing, or the like.

The image file and image management information used to manage images contained in the image file are stored in the hard disk drive 14. The images and image management information are managed while being mutually associated. The image management information consists of information specified in object units describing objects contained in each image and supplementary information of the image.

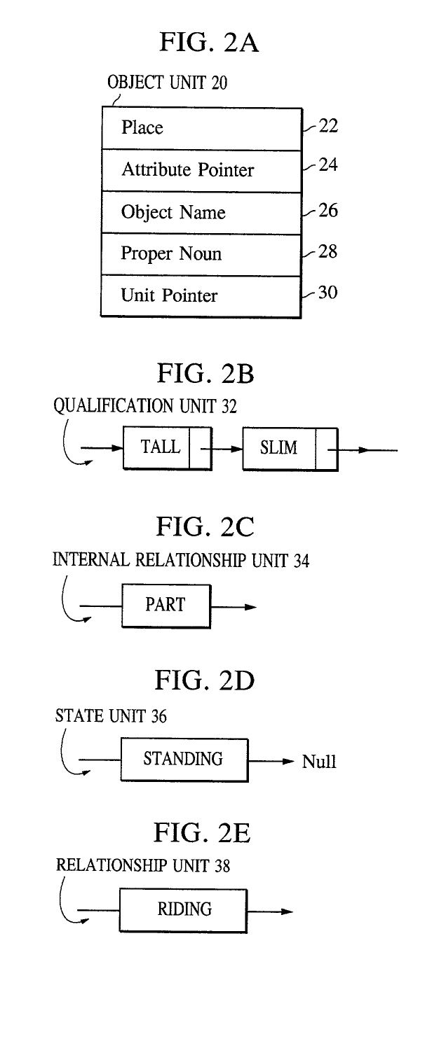

Next, the object unit will be described with reference to FIG. 2A to FIG. 2E. FIG. 2A to FIG. 2E show the structure of the object unit employed in managing an image by the image managing apparatus shown in FIG. 1.

An object unit 20 describing an object contained in an image consists of, as shown in FIG. 2A, a place division 22, an attribute pointer division 24, an object name division 26, a proper noun division 28, and a unit pointer division 30. The position of the object in a screen is specified in the place division 22. A pointer indicating a qualification unit is specified in the attribute pointer division 24. A general name is specified in the object name division 26. A proper noun is specified in the proper noun division 28. Pointers indicating other object units are specified in the unit pointer division 30.

FIG. 2B schematically shows a qualification unit 32. The pointer indicating a qualification unit indicates a position at which the qualification unit resides. Qualifiers appended to the object are specified in the qualification unit. The qualification unit is structured so that a plurality of qualifiers can be specified therein and one object can thus be qualified with a plurality of qualifiers.

The pointers indicating other objects indicate other object units to be linked. The other object units include, as shown in FIG. 2C, an internal relationship unit 34 in which an object included in an object (for example, an object of a face included in an object of a human being) is specified. The internal relationship unit represents an internal relationship between objects. The other object units also include, as shown in FIG. 2D, a state unit 36 for expressing the state of an object. For example, when it is necessary to express the state of an object of a human being, that is, a “standing” state, a state unit expressing the “standing” state is linked to the object unit describing the human being.

The other object units also include, as shown in FIG. 2E, a relationship unit 38 for expressing the relationship of an object to another object. For example, an object of a human being and an object of a motorcar have the relationship that the human being is riding in the motorcar. The relationship unit 38 expresses the relationship that the human being is riding. The relationship unit 38 is linked to two object units and specifies one verb. A plurality of relationship units is permitted. For example, for expressing the relationship that the human being is riding in the motorcar and driving it, relationship units having “riding” and “driving” specified therein respectively are linked to the object unit describing the human being.

Supplementary information of an image includes imaging-related data, special object data, category data, impression data, time data, place data, weather data, and event data. The supplementary information will be detailed later.

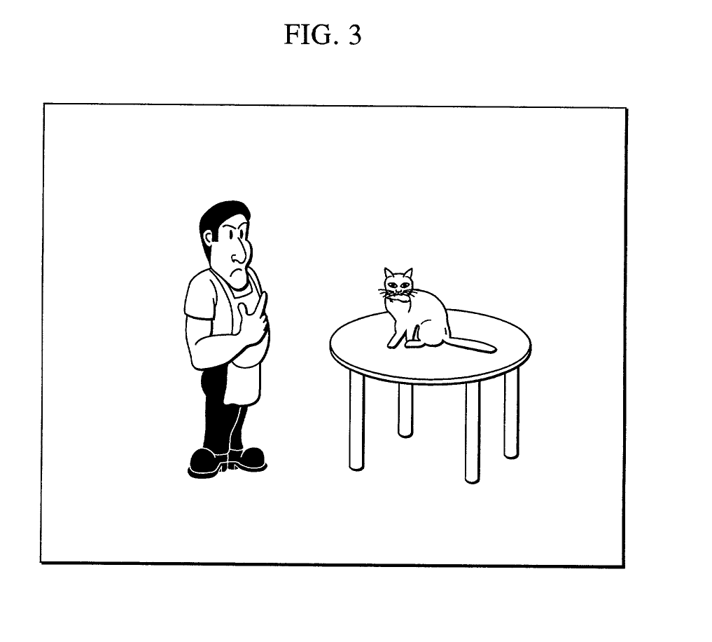

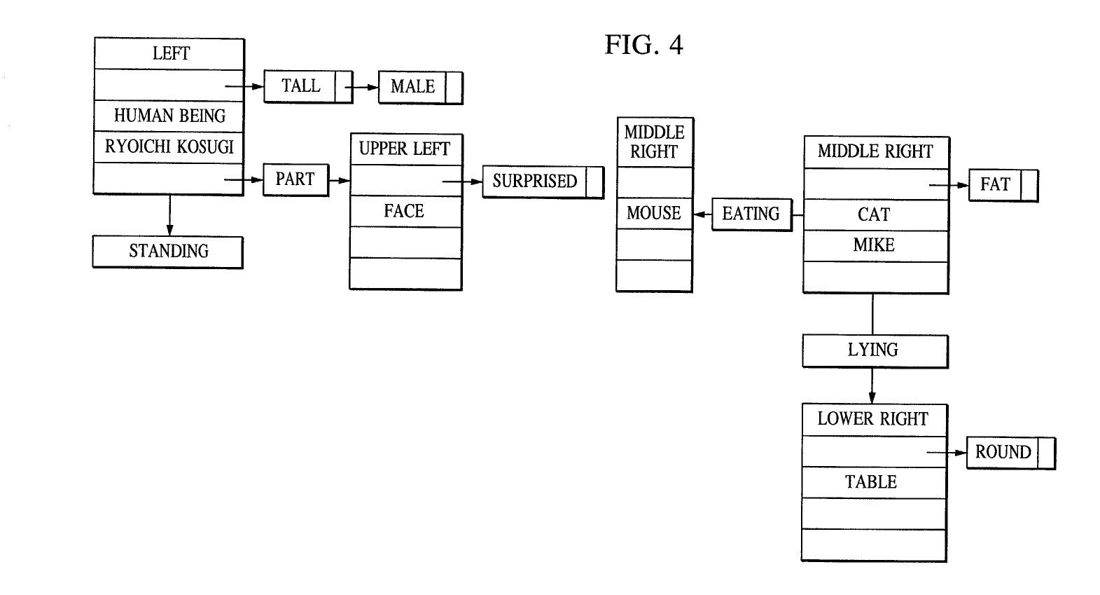

Next, an example of descriptions specified in an object unit will be described with reference to FIG. 3 and FIG. 4. FIG. 3 shows an example of images managed by the image managing apparatus shown in FIG. 1. FIG. 4 shows an example of descriptions specified in an object unit assigned to the image shown in FIG. 3.

The image shown in FIG. 3 shows a man standing on the left surprised at a cat eating a mouse on a round table on the right. In the image, the cat is regarded as a first object, the mouse is regarded as a second object, the table is regarded as a third object, and the man is regarded as a fourth object. As shown in FIG. 4, an object unit in which “middle right” is specified as a position, “fat” is specified as a qualifier, “cat” is specified as a general name, and “Mike” is specified as a proper noun is assigned to the first object (cat). An object unit in which “middle right” is specified as a position and “mouse” is specified as a general name is assigned to the second object (mouse). However, no description of a qualifier and a proper noun are specified in the object unit. An object unit in which “lower right” is specified as a position, “round” is specified as a qualifier, and “table” is specified as a general name is assigned to the third object (table). However, no description of a proper noun is specified in the object unit. An object unit in which “left” is specified as a position, “tall” and “male” are specified as qualifiers, “human being” is specified as a general name, and “Ryoichi Kosugi” is specified as a proper noun is assigned to the fourth object (man). An internal relationship unit and a state unit are linked to the object unit describing the fourth object. The internal relationship unit is a unit describing an object of a face included in the fourth object, wherein “upper left” is specified as a position, “surprised” is specified as a qualifier, and “face” is specified as a general name. No description of a proper noun is specified in the internal relationship unit. The state of the fourth object, that is, “standing” is specified in the state unit. Moreover, a relationship unit expressing the relationship between the first object and the fourth object links the first and fourth objects. A verb “eating” expressing that the cat is eating the mouse is specified in the relationship unit. Moreover, a relationship unit expressing the relationship between the first object and the third object links the first and third objects. A verb “lying” expressing that the cat is lying on the table is specified in the relationship unit.

Owing to the descriptions, unlike when words serving as keywords are merely enumerated as they are conventionally, it is possible to clarify what objects an image consists of and how the image is composed.

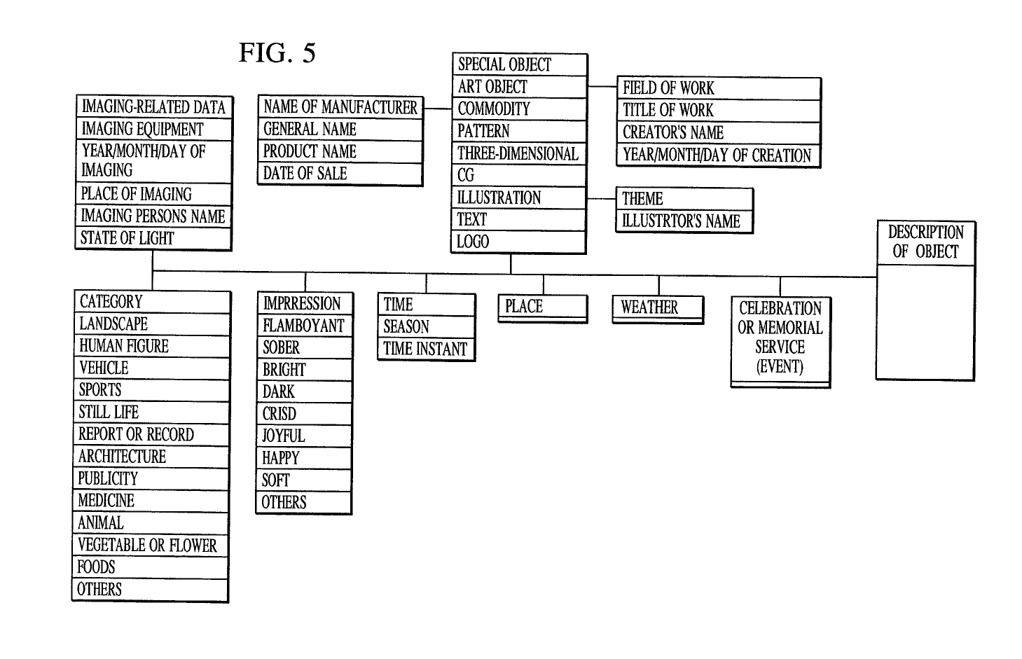

Next, supplementary information of an image will be described with reference to FIG. 5. FIG. 5 shows the structure of supplementary information employed in managing an image by the image managing apparatus shown in FIG. 1. The supplementary information of an image is, as shown in FIG. 5, managed in association with the image together with the foregoing descriptions of objects, that is, the object units (including units linked to the units). The supplementary information includes imaging-related data, special object data, category data, impression data, time data, place data, weather data, and event data.

In the imaging-related data, an imaging person, a year/month/day/time of imaging, a place of imaging, imaging equipment, and the state of light for imaging (forward light or back light) can be specified. For example, when an image is a photograph of a human figure, the human figure can be described in an object unit but a person taking the photograph, or imaging person, cannot be described. However, the imaging person can be specified in the imaging-related data. Consequently, the imaging person and the imaged human figure can be used as keywords to retrieve the image. The retrieval using the keywords permits reliable extraction of candidate images from a narrow range of images.

In the special object data, an art object, a commodity, a frame (pattern), a three-dimensional image, a computer graphic (CG), an illustration, a test, and a logo can be specified. The art object includes a painting and is detailed with the field of a work, the title of the work, a producer's name, and a year/month/day of production. The commodity is detailed with a general name, a product name, and a date of sale. The frame includes a picture frame enclosing a photograph. The illustration is detailed with an illustrator's name and the title of an illustration. For example, when the special object data is appended to an image that is a painting, the painting can be retrieved using the painter and objects appearing in the painting as keywords. Candidate images can be reliably extracted from a narrow range.

The category data represents the category of an image such as a landscape image, a figure image, or a vehicle image. The impression data represents an impression on an image. For example, such an impression as “flamboyant,” “sober,” or “bright” is specified. The time data represents a season and a time of day. If a year/month/day of imaging is specified in the imaging-related data, the time data may be thought to be unnecessary. However, in many cases, it is impossible to enter a year/month/day of imaging accurately for retrieval. If a season or the like is specified, it often works effectively during retrieval. The place data represents a place expressed in an image. The weather data represents weather such as raining or snowing. The event data represents a celebration or memorial service such as a festival for children of three, five, and seven years of age or a wedding.

Owing to the foregoing supplementary information, information that cannot be expressed using the object unit can be associated with an image. When a query indicating information corresponding to information specified in an object unit and information corresponding to supplementary information is designated for retrieval, candidate images can be extracted very precisely.

For example, assume that the image shown in FIG. 3 is a painting produced by a painter Mr. M. For retrieving the image, a retriever designates a query indicating a painting produced by painter Mr. M and depicting that a man standing on the left is surprised at a cat. Candidate images including the image shown in FIG. 3 are then extracted. If object units alone were described, other images meeting the requirement that a man standing left is surprised at a cat would be extracted. If numerous images meeting the requirement are stored, the number of candidate images to be extracted would be so large that it would take a great deal of time to select an intended image from among the numerous candidate images. In contrast, when “painting” and “producer M” are appended as supplementary information of an image together with the object units to the image, the number of candidate images including the image shown in FIG. 3 is small. The image shown in FIG. 3 can therefore be extracted very precisely. Namely, a high retrieving ability can be achieved.

As mentioned above, in the present embodiment, each image is managed in such a manner that image management information consisting of information specified in object units, which describe objects appearing in an image, and supplementary information are associated with the image. Retrieval can therefore be achieved using a query indicating the information specified in the object units, which describe the objects in the image, and the supplementary information. Candidate images can therefore be extracted very precisely. Namely, a retrieving ability can be improved.

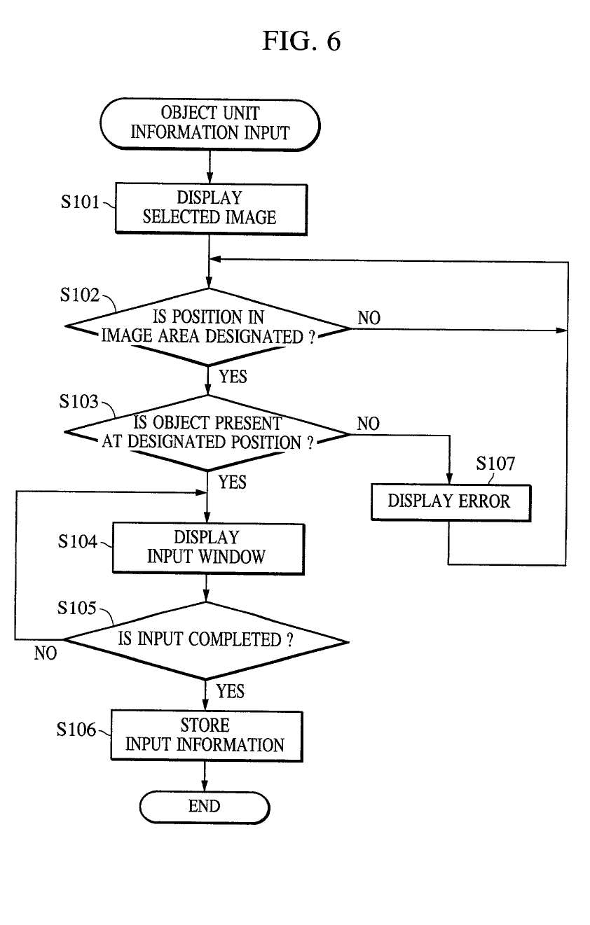

Next, an object unit information input procedure for inputting information to be specified in an object unit will be described with reference to FIG. 6. FIG. 6 is a flowchart describing a procedure for inputting object unit information to be used by the image managing apparatus shown in FIG. 1.

In the object unit information input, as described in FIG. 6, first, at step S101, an image for which management information is input is selected and displayed on the display 17. Control is then passed to step S102. Control waits until a position in the displayed image area is designated using the keyboard 15 or the mouse 16. When a position in the image area is designated, control is passed to step S103. It is judged from position information of the designated position whether an object is present. If no object is present at the designated position, control is passed to step S107. An error is indicated. Control is then returned to the step S102 and waits until a position in an image area is designated.

If an object is present at the designated position, control is passed to step S104. An input window is displayed at the designated position within the image area. The input window may be structured as an entry form having items shown as in FIG. 2A written therein. In this case, the input window consists of divisions in which the position of an object in a screen, a pointer indicating a qualification unit, a general name, a proper noun, and pointers indicating other object units are specified respectively. Information concerning a position may be input using the keyboard 15 or the mouse 16. Alternatively, position information representing an object located at the position may be automatically input based on the position information of the designated position.

For inputting information to be specified in a qualification unit, the qualification unit is designated using the keyboard 15 or the mouse 16. An input window used to input information to be specified in the qualification unit, that is, qualifiers, is then displayed. Qualifiers are entered in the input window. The qualification unit having the qualifiers specified therein is automatically associated with the object. A general name and a proper noun are entered in the input window used to input information to be specified in the object unit. Other object units include the internal relationship unit shown in FIG. 2C, the state unit shown in FIG. 2D, and the relationship unit shown in FIG. 2E. A window used to select any of the units in which information to be input is specified is displayed. Any of the internal relationship unit, the state unit, and the relationship unit in which information to be input is specified is selected in the window, and then information is input. Input of information to be specified in the relationship unit will be described later.

Thereafter, control is passed to step S105. It is judged whether input of information to be specified in the items of the displayed input window has been completed. If input has been completed, control is passed to step S106. The input information is stored in association with the displayed image in the hard disk drive 14. This procedure is then terminated.

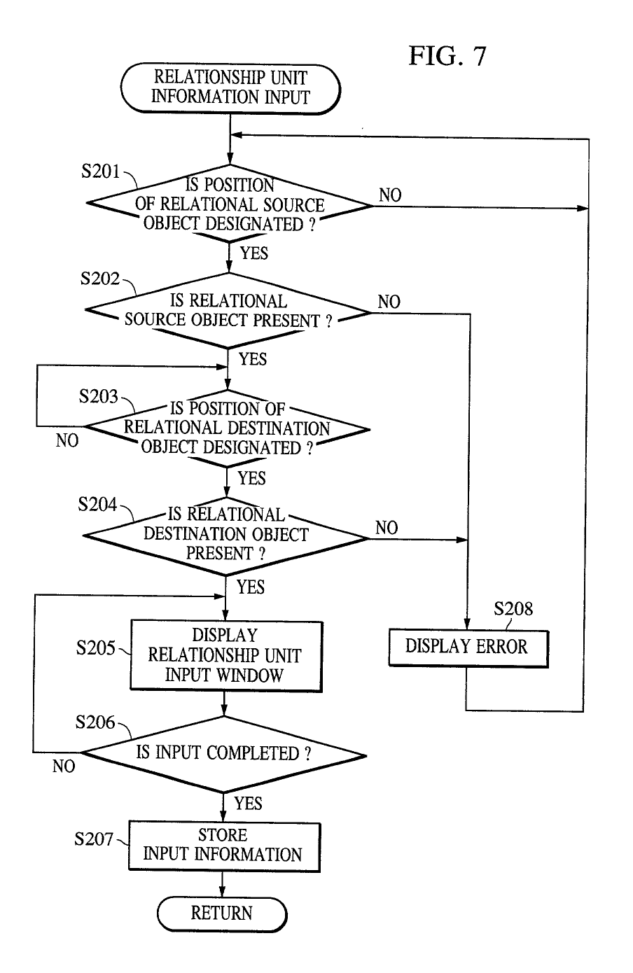

Next, input of information to be specified in the relationship unit will be described with reference to FIG. 7. FIG. 7 is a flowchart describing the input of relationship unit information to be used by the image managing apparatus shown in FIG. 1.

Assume that input of information to be specified in the relationship unit is selected at step S104 in FIG. 6. As described in FIG. 7, first, at step S201, control waits until the position of a relational source object in a displayed image is designated. If the position of the relational source object is designated, control is passed to step S202. It is then judged whether the relational source object is present at the designated position. If no relational source object is present at the designated position, control is passed to step S208. An error is then indicated, and control is returned to step S201.

If the relational source object is present at the designated position, control is passed to step S203. Control then waits until the position of a relational destination object relative to the relational source object is designated. If the position of the relational destination object is designated, control is passed to step S204. It is then judged whether the relational destination object is present at the designated position. If no relational destination object is present at the designated position, control is passed to step S208. An error is indicated, and control is returned to step S201.

If the relational destination object is present at the designated position, control is passed to step S205. A relationship unit input window is displayed. Herein, the example shown in FIG. 3 is taken for instance. Assume that the cat is regarded as a relational source and the table is regarded as a relational destination. For inputting information to be specified in the relationship unit, the table is designated as an object serving as the relational destination of the cat. The information “lying” is input in order to express the relationship between the object of the cat and the object of the table.

Control is then passed to step S206. It is then judged whether input has been completed. If input has been completed, control is passed to step S207. Input information specified in the relationship unit is stored in the hard disk unit 14. For example, the information “lying” links, as shown in FIG. 4, the object of the cat and the object of the table. This procedure is then exited. Control is then returned to the step S104 in FIG. 6.

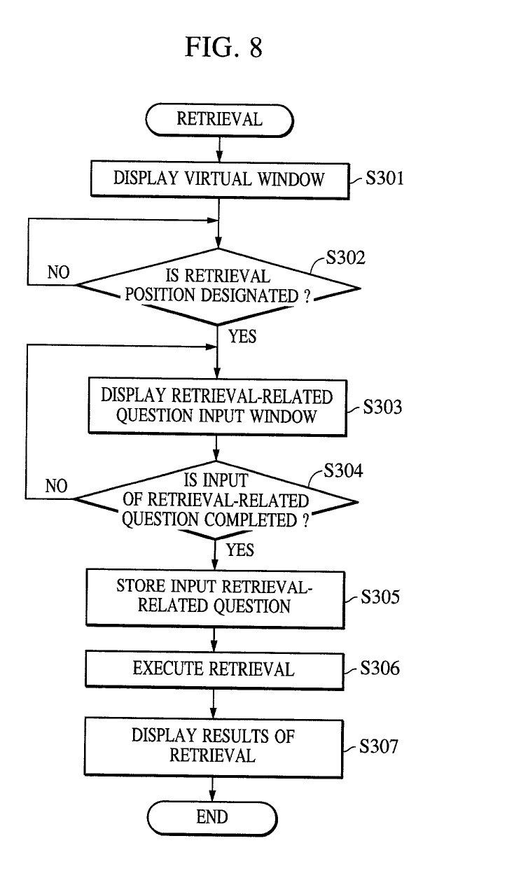

Next, a retrieval procedure run by the image managing apparatus will be described with reference to FIG. 8. FIG. 8 is a flowchart describing a retrieval procedure performed by the image managing apparatus shown in FIG. 1.

A retrieval procedure is run for retrieving an image stored in the hard disk drive 14. As described in FIG. 8, first, at step S301, a virtual window virtually defining an image area is displayed on the display 17. Control is then passed to step S302 and waits until a position in the virtual window is designated. If a position in the virtual window is designated, control is passed to step S303. A retrieval-related query input window is displayed. The retrieval-related query input window is realized with a window having the same structure as the object unit shown in FIG. 2. The window is used to input necessary retrieval information. For example, for retrieving an image with an object of the man shown in FIG. 3 as a reference, “left,” “tall,” “male,” and “standing” are input as shown in FIG. 4.

Control is then passed to step S305. The input retrieval-related query is stored in the RAM 13. At the next step S306, retrieval is performed with reference to the input retrieval-related query and image management information (object units). At step S307, candidate images extracted through retrieval are displayed on the display 17. This procedure is then exited.

In this retrieval, retrieval information concerning one object is input. Alternatively, information concerning a plurality of objects may be input simultaneously. In this case, the steps S302, 303, and 304 are repeated for each object.

As mentioned above, according to the present embodiment, the adoption of object units makes it possible to clarify the kinds of objects an image includes and how the image is composed. The object unit consists of a place division, an attribute pointer division, an object name division, a proper noun division, and a unit pointer division. The position of an object in a screen is specified in the place division. A pointer indicating a qualification unit is specified in the attribute pointer division. A general name is specified in the object name division. A proper noun is specified in the proper noun division. Pointers indicating other object units are specified in the unit pointer division. For retrieval, retrieval information can be input as if a speech was made. A candidate image desired by a retriever can be retrieved with a high probability. Moreover, information to be specified in an object unit can be input easily by inputting object unit information and/or relationship unit information. The object unit information relates to information concerning an object. Furthermore, retrieval information can be input easily.

The present embodiment relates to one apparatus. Alternatively, the present invention may be applied to a system consisting of a plurality of equipment (for example, a host computer, interface equipment, a reader, a printer, etc.).

Moreover, a working mode described below is included in the scope of the present invention. Namely, a computer (CPU or MPU) included in an apparatus or a system is connected to various devices so that the various devices can be operated in order to realize the aforesaid constituent features of the embodiment. Coded software programs for realizing the constituent features of the embodiment are supplied to the computer included in the system or apparatus. The computer included in the system or apparatus instructs the various devices to operate according to the programs.

In the working mode, the coded software programs realize the constituent features of the embodiment. The programs themselves and a means for supplying the programs to the computer, for example, a storage medium in which the programs are stored, constitute the present invention.

The storage medium in which the programs are stored may be, for example, a floppy disk, a hard disk, an optical disk, a magneto-optical disk, a CD-ROM, a magnetic tape, a nonvolatile memory card, or a ROM, for example.

In the foregoing mode, when the computer runs any of the supplied programs, the associated constituent feature of the embodiment is realized. In another mode, when a coded program cooperates with an operating system (OS) residing in a computer or with another application program software, the associated constituent feature of the embodiment is realized. Even this mode is included in the scope of the present embodiment.

In still another mode, a supplied coded program is stored in a memory included in an extension board of the computer or an extension unit connected to the computer. Thereafter, a CPU or the like included in the extension board or extension unit carries out a part or the whole of actual processing according to instructions described in the program. The associated constituent feature of the aforesaid embodiment is realized through the processing. Even this mode is included in the scope of the present invention.

As described so far, according to the present invention, an image managing apparatus includes input means and managing means. The input means inputs information to be specified in an object unit assigned to each object contained in an image. The object unit consists of unit divisions in which such information as a general name, a qualifier, a proper noun, and a position are specified. The managing means stores the object unit having input information specified therein in an object unit memory means, and manages images stored in memory means in association with object units stored in the object unit memory means. This results in an improved retrieving ability.

According to the present invention, the input means of the image managing apparatus includes display means, position designating means, and input window display means. The display means displays an image. The position designating means designates the position of an object concerned in the displayed image. The input window display means displays an object unit input window, which is used to input information to be specified in an object unit, at the designated position. Consequently, information to be specified in an object unit for managing an image can be input easily.

According to the present invention, the managing means of the image managing apparatus includes retrieval information input means and retrieving means. The retrieval information input means inputs retrieval information corresponding to information specified in object units. The retrieving means retrieves candidate images conformable to the retrieval information from the memory means according to the retrieval information and the information specified in the object units.

According to the present invention, an image managing apparatus includes input means and managing means. The input means inputs information concerning each object appearing in an image. The managing means stores the input information in a management information memory means and manages information stored in the management information memory means in association with images. The input means includes display means, position designating means, and input window display means. The display means displays an image. The position designating means designates the position of an object of interest in the displayed image. The input window display means displays an information input window used to input information concerning an object at the designated position. Information used to manage an image can therefore be input easily.

According to the present invention, an image retrieving apparatus includes retrieval information input means for inputting retrieval information and extracting means for extracting candidate images from an image memory according to the retrieval information. The input means includes display means, position designating means, retrieval information input window display means, and retrieval information acquiring means. The display means displays a virtual window virtually defining an image area. The position designating means designates a position in the displayed virtual window. The retrieval information input window display means displays a retrieval information input window used to input information concerning the retrieval information at the designated position. The retrieval information acquiring means acquires position information of the designated position in the virtual window and the information entered in the retrieval information input window as retrieval information. The retrieval information used to retrieve an image can therefore be input easily.

What is claimed is:

1. An image managing apparatus for managing retrievable images, comprising:
input means for inputting relevant information concerning each object in an image; and
memory means for storing the relevant information input by said input means in association with respective objects.

2. An image managing apparatus according to claim 1, wherein the relevant information includes at least one of a general name of an object, a qualifier therefor, a proper noun thereof, and a position thereof.

3. An image managing apparatus according to claim 1, wherein the relevant information includes information expressing a state of an object in an image.

4. An image managing apparatus according to claim 1, wherein the relevant information is relationship information expressing a relationship between one object in an image and another object in the image.

5. An image managing apparatus according to claim 2, wherein a plurality of words can be specified as the qualifier.

6. An image managing apparatus according to claim 1, wherein said input means includes position designating means for designating a position of an object of interest in an image displayed on a display screen, and display means for displaying an input window used to input relevant information at the designated position.

7. An image managing apparatus according to claim 6, wherein the position designating means designates positions of two mutually-related objects in an image.

8. An image managing apparatus according to claim 1, further comprising retrieval requirement input means for inputting requirements for retrieval, and image retrieving means for retrieving images that meet the requirements for retrieval input by said retrieval requirement input means.

9. An image managing apparatus according to claim 1, wherein said input means inputs supplementary information including at least one of imaging-related information of an image, special object information thereof, category information thereof, impression information thereof, time information thereof, place information thereof, weather information thereof, and event information thereof.

10. An image retrieving apparatus for retrieving images, comprising:
memory means for storing objects contained in images in association with relevant information concerning the objects;
retrieval requirement input means for inputting requirements for retrieval; and
retrieving means for retrieving images that meet the requirements for retrieval input by said retrieval requirement input means based on the relevant information stored in said memory means.

11. An image retrieving apparatus according to claim 10, wherein the relevant information includes at least one of a general name of an object, a qualifier therefor, a proper noun thereof, and a position thereof.

12. An image retrieving apparatus according to claim 10, wherein the relevant information includes information expressing a state of an object in an image.

13. An image retrieving apparatus according to claim 10, wherein the relevant information is relationship information expressing a relationship between one object in an image and another object in the image.

14. An image retrieving apparatus according to claim 11, wherein a plurality of words can be specified as the qualifier.

15. An image retrieving apparatus according to claim 10, further comprising a position designating means for designating a position of an object of interest in an image displayed on a display screen, and display means for displaying an input window used to input relevant information at the designated position.

16. An image retrieving apparatus according to claim 15, wherein said position designating means designates positions of two mutually-related objects in an image.

17. An image retrieving apparatus according to claim 10, wherein said input means inputs supplementary information including at least one of imaging-related information of an image, special object information thereof, category information thereof, impression information thereof, time information thereof, place information thereof, weather information thereof, and event information thereof.

18. An image managing method for managing retrievable images, comprising:
an input step of inputting relevant information concerning each object in an image; and
a storage step of storing the relevant information input in said input step in association with respective objects.

19. An image managing method according to claim 18, wherein the relevant information includes at least one of a general name of an object, a qualifier therefor, a proper noun thereof, and a position thereof.

20. An image managing method according to claim 18, wherein the relevant information includes information expressing a state of an object in an image.

21. An image managing method according to claim 18, wherein the relevant information is relationship information expressing a relationship between one object in an image and another object in the image.

22. An image managing method according to claim 19, wherein a plurality of words can be specified as the qualifier.

23. An image managing method according to claim 18, wherein said input step includes a position designation step of designating a position of an object of interest in an image displayed on a display screen, and a display step of displaying an input window used to input relevant information at the designated position.

24. An image managing method according to claim 23, wherein, in the position designation step, positions of two mutually-related objects are designated in an image.

25. An image managing method according to claim 18, further comprising a retrieval requirement input step of inputting requirements for retrieval, and an image retrieval step of retrieving images that meet the requirements for retrieval input in said retrieval requirement input step.

26. An image managing method according to claim 18, wherein, in said input step, supplementary information including at least one of imaging-related information of an image, special object information thereof, category information thereof, impression information thereof, time information thereof, place information thereof, weather information thereof, and event information thereof is input.

27. An image retrieving method for retrieving images, comprising:
a storage step of storing objects contained in images in association with relevant information concerning the objects;
a retrieval requirement input step of inputting requirements for retrieval; and
a retrieval step of retrieving images that meet the requirements for retrieval input in said retrieval requirement input step based on the stored relevant information.

28. An image managing method according to claim 27, wherein the relevant information includes at least one of a general name of an object, a qualifier therefor, a proper noun thereof, and a position thereof.

29. An image managing method according to claim 27, wherein the relevant information includes information expressing a state of an object in an image.

30. An image managing method according to claim 27, wherein the relevant information is relationship information expressing a relationship between one object in an image and another object in the image.

31. An image managing method according to claim 28, wherein a plurality of words can be specified as the qualifier.

32. An image managing method according to claim 27, further comprising a position designation step of designating a position of an object of interest in an image displayed on a display screen, and a display step of displaying an input window used to input relevant information at the designated position.

33. An image managing method according to claim 32, wherein, in said position designation step, positions of two mutually-related objects are designated in an image.

34. An image managing method according to claim 27, wherein, in said storage step, supplementary information including at least one of imaging-related information of an image, special object information thereof, category information thereof, impression information thereof, time information thereof, place information thereof, weather information thereof, and event information thereof is stored.

35. A storage medium in which is stored a program for implementing an image managing method for managing retrievable stored images, the program comprising:
program coded for an input step of inputting relevant information concerning each object in an image; and
program coded for a storage step of storing the relevant information input in the input step in association with respective objects stored in said storage medium.

36. A storage medium according to claim 35, wherein the relevant information includes at least one of a general name of an object, a qualifier therefor, a proper noun thereof, and a position thereof.

37. A storage medium according to claim 35, wherein the relevant information includes information expressing a state of an object in an image.

38. A storage medium according to claim 35, wherein the relevant information is relationship information expressing a relationship between one object in an image and another object in the image.

39. A storage medium according to claim 36, wherein a plurality of words can be specified as the qualifier.

40. A storage medium according to claim 35, wherein said program coded for the input step includes program coded for a position designation step of designating a position of an object of interest in an image displayed on a display screen, and program coded for a display step of displaying an input window used to input relevant information at the designated position.

41. A storage medium according to claim 40, wherein, in the position designation step, positions of two mutually-related objects are designated in an image.

42. A storage medium according to claim 35, wherein the program further comprises program coded for a retrieval requirement input step of inputting requirements for retrieval, and program coded for an image retrieval step of retrieving images that meet the requirements for retrieval input in the retrieval requirement input step.

43. A storage medium according to claim 35, wherein, in the input step, supplementary information including at least one of imaging-related information of an image, special object information thereof, category information thereof, impression information thereof, time information thereof, place information thereof, weather information thereof, and event information thereof is input.

44. A storage medium in which is stored a program for implementing an image retrieving method for retrieving stored images, the program comprising:
program coded for a storage step of storing objects contained in images in association with relevant information concerning the objects;
program coded for a retrieval requirement input step of inputting requirements for retrieval; and
program coded for a retrieval step of retrieving images that meet the requirements for retrieval input at the retrieval requirement input step based on the stored relevant information stored in said storage medium.

45. A storage medium according to claim 44, wherein the relevant information includes at least one of a general name of an object, a qualifier therefor, a proper noun thereof, and a position thereof.

46. A storage medium according to claim 44, wherein the relevant information includes information expressing a state of an object in an image.

47. A storage medium according to claim 44, wherein the relevant information is relationship information expressing a relationship between one object in an image and another object in the image.

48. A storage medium according to claim 45, wherein a plurality of words can be specified as the qualifier.

49. A storage medium according to claim 44, wherein the program further comprises program coded for a position designation step of designating a position of an object of interest in an image displayed on a display screen, and program coded for a display step of displaying an input window used to input relevant information at the designated position.

50. A storage medium according to claim 49, wherein, in the position designation step, positions of two mutually-related objects are designated in an image.

51. A storage medium according to claim 44, wherein, in the storage step, supplementary information including at least one of imaging-related information of an image, special object information thereof, category information thereof, impression information thereof, time information thereof, place information thereof, weather information thereof, and event information thereof is stored.
